(19) United States
(12) Patent Application Publication
(10) Pub. No.: US 2025/0356677 A1
(43) Pub. Date: Nov. 20, 2025

(54) MATCHING SYSTEM FOR IMAGES AND TEXT DESCRIPTIONS IN SPECIFICATIONS

(71) Applicant: Quanta Computer Inc., Taoyuan City (TW)

(72) Inventors: Wen-Kuang CHEN, Taoyuan City (TW); Tsai-Hsing LU, Taoyuan City (TW); Chien-Kuo HUNG, Taoyuan City (TW); Chun-Hung CHEN, Taoyuan City (TW); Chen-Chung LEE, Taoyuan City (TW)

(21) Appl. No.: 18/804,477

(22) Filed: Aug. 14, 2024

(30) Foreign Application Priority Data
May 15, 2024 (TW) 113117935

(51) Int. Cl. G06V 30/19; G06V 30/14; G06V 30/414; G06V 30/422

(52) U.S. Cl. CPC G06V 30/19093; G06V 30/1452; G06V 30/1908; G06V 30/1912; G06V 30/414; G06V 30/422

(57) ABSTRACT

Provided is a matching system for images and text descriptions in a specification. The matching system includes an image-and-text recognition device, receiving a specification and recognizing image blocks and text blocks thereon, the image block having corresponding covering range; and a preference value calculation device, assigning preference value to each of the text blocks according to positional relationship between the above-mentioned text block and the above-mentioned image block, and the contents of the above-mentioned text block, for matching the image blocks and the text blocks.

### CROSS REFERENCE TO RELATED APPLICATIONS

This Application claims priority of Taiwan Patent Application No. 113117935, filed on May 15, 2024, the entirety of which is incorporated by reference herein.

### BACKGROUND OF THE INVENTION

### Field of the Invention

The present invention relates to a matching system, and in particular it relates to a matching system for the illustrations and the text descriptions in specifications.

### Description of the Related Art

Usually, a specification contains various different illustrations (image blocks) and text descriptions. The text descriptions, for example, may be of the diameter, length, quantity of screws, or the dimensions and checking locations of other parts or mechanical materials, etc. In the past, quality control personnel had to manually mark the items that required inspection to help factory workers to conduct acceptance according to the marked items. However, due to the diversity of specifications and the complexity of text descriptions, this work was very time-consuming and error-prone. Therefore, quality control personnel on the production line today need to spend a lot of time dealing with the correspondence between illustrations and the dimensions indicated in the specifications. There is currently no more efficient way to perform marking and matching operations on specifications.

Traditionally, quality control personnel must mark the illustrations (such as mechanism, image blocks) and descriptive texts (such as size specifications) on the specification based on past experience. However, at present there is no suitable method for matching images and texts that can be applied to complex specifications. The matching of product patterns and text descriptions is commonly seen, but to apply such matching to a specification, the required text content, such as quantity and size descriptions, must be extracted from the complex text descriptions. Sizes (or dimensions) listed in a specification can be marked in a variety of ways, and the locations of these marks are not fixed. Therefore, quality control personnel must spend a lot of time to match and mark specific inspection items with dimensions. This is a complicated and time-consuming process.

In addition, in a specification, there will be different illustrations representing different inspection items. Size labels are usually located near illustrations, but because they are manually marked and provided by the customer or the company's research and development unit, there are no established rules to place the blocks corresponding to text in specific positions above, below, left, and right of the illustration, nor how far away from the illustration it should be. This leads to difficulty for automatically marking the illustrations and their corresponding descriptive texts in specifications.

### BRIEF SUMMARY OF THE INVENTION

Accordingly, in order to solve the problems mentioned above, it is desirable to provide a matching system that can be applied to the illustrations and text descriptions in specifications. By automating the matching process, it can improve marking efficiency, speed up the process, and reduce artificial marking errors.

One embodiment of the present invention provides a matching system for images and text descriptions in a specification. The matching system includes an image-and-text recognition device and a preference-value calculation device. The image-and-text recognition device is configured to receive a specification, and to recognize image blocks and text blocks on the specification through image and text recognitions. Here, the image blocks further have corresponding covering ranges. The preference-value calculation device is configured to assign preference values to the text blocks for matching with the image blocks based on position relationships between the text blocks and the image blocks, and content characteristics of the text blocks.

In a matching system according to some embodiment of the present invention, the preference-value calculation device is further configured to: (1) calculate overlapping areas of the text blocks and the covering range of a first image block, and obtain area scores of the text blocks which overlap the first image block; (2) for the text blocks which overlap the first image block, calculate distances from the first image block to obtain distance scores of the text blocks; (3) based on positions and descriptive forms of the text blocks which overlap the first image block, and a frame range of the first image block, determine negative scores of the text blocks which overlap the first image block; and (4) based on the area scores, distance scores and negative scores, calculate the preference values of the text blocks which overlap the first image block.

In a matching system according to some embodiment of the present invention, the preference-value calculation device is further configured to add the text blocks having preference values that satisfy a selection condition to a selection list of the first image block. Also, the matching system further includes a filtering device. When a first text block in the selection list of the first image block is associated with a second image block of the image blocks, the filtering device determines to keep or delete the first text block in the selection list of the first image block based on the distance scores, the area scores, and coverage points.

In a matching system according to some embodiment of the present invention, the filtering device is configured to compare the distance scores of the first text block corresponding to the first image block and the second image block respectively; when the distance score of the first text block is lower, the first text block is deleted from the selection list of the first image block. When the distance scores of the first text block corresponding to the first image block and the second image block respectively are the same, the filtering device further compares the area scores of the first text block corresponding to the first image block and the second image block respectively, and when the area score of the first text block corresponding to the first image block is lower, the first text block is deleted from the selection list of the first image block. When the area scores of the first text block corresponding to the first image block and the second image block respectively are the same, the filtering device further compares the coverage points of the first text block corresponding to the first image block and the second image block respectively, in addition, when the coverage point of the first text block is lower, the first text block is kept in the selection list of the first image block, and when the coverage point of the first text block is higher, the first text block is deleted from the selection list of the first image block.

In a matching system according to some embodiment of the present invention, the matching system further includes a recommendation device. When the selection list of the first image block has only one text block, the recommendation device keeps the text block; and when the selection list of the first image block has multiple text blocks, the recommendation device selects one text block in the selection list of the first image block based on a highest score strategy or a relative position strategy. When based on the highest score strategy, the recommendation device selects to match the text block with the highest preference value in the selection list to the first image block; and when based on the relative position strategy, the recommendation device selects the text block which is arranged horizontally or vertically relative to the first image block and has the highest preference value among the text blocks in the selection list.

In a matching system according to some embodiment of the present invention, the size of the image block is taken as basic unit; and

the covering range corresponding to the image block is arranged with the image block as the center, horizontally extending a first predetermined number of basic units to the left and right respectively, and on the upper and lower sides of the image block horizontally extending a second predetermined number of basic units, wherein the first predetermined number is 3.5, and the second predetermined number is 5, for example.

### BRIEF DESCRIPTION OF THE DRAWINGS

The present invention can be more fully understood by reading the subsequent detailed description and examples with references made to the accompanying drawings, wherein:

FIG. 1 shows an example of “illustrations” commonly seen in specifications and “text descriptions” corresponding to the illustrations.

FIG. 2 shows a configuration block diagram of a matching system for the illustrations and text descriptions in the specification according to an embodiment of the present invention.

FIG. 3 shows a schematic diagram of the image block P and the corresponding covering range COV.

FIG. 4 shows a schematic diagram of the image block P, the corresponding covering range COV, and the text block T.

FIG. 5 shows a schematic diagram of the processing flow of a preference-value calculation device.

FIG. 6A shows an example of one sub-range (CU) of the covering range (COV) overlapping the text block (T).

FIG. 6B shows an example of one sub-range (CU) of the covering range (COV) non-overlapping the text block (T).

FIG. 7 shows an operation flow of the filtering device of this embodiment.

FIG. 8 shows the correspondence between the image blocks and the text blocks before and after processing by the filtering device.

FIG. 9 shows an operation flow of the recommendation device of this embodiment of the matching system.

### DETAILED DESCRIPTION OF THE INVENTION

The following description is a preferred implementation for completing the invention. Its purpose is to describe the basic spirit of the invention, but it is not intended to limit the invention. The practical invention content must be referred to the subsequent patent application claims.

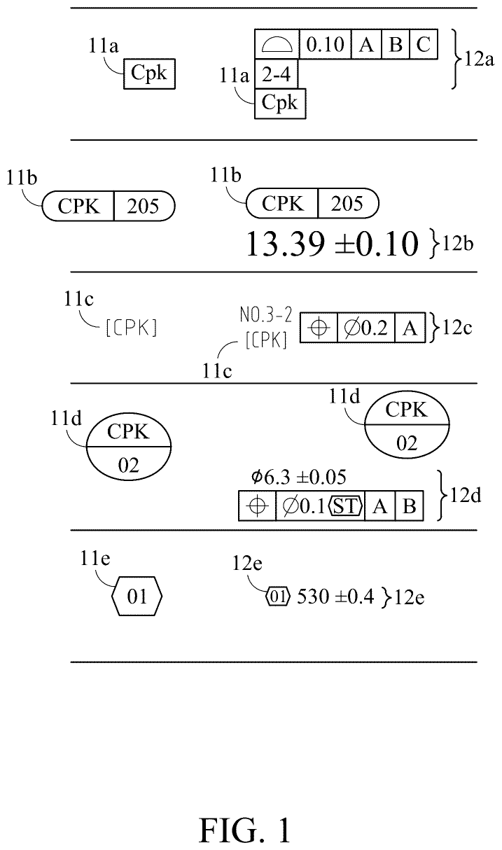

FIG. 1 shows “illustrations” commonly seen in a specification, such as the “square box Cpk” 11a, “(oval) circle Cpk” 11b, “square brackets Cpk” 11c, “(oval) circle Cpk” 11d, and “hexagon” 11e, and the “text descriptions” 12a˜12e corresponding to these illustrations 11a˜11e. What is shown in FIG. 1 is for example only and is not intended to limit the content of the specification.

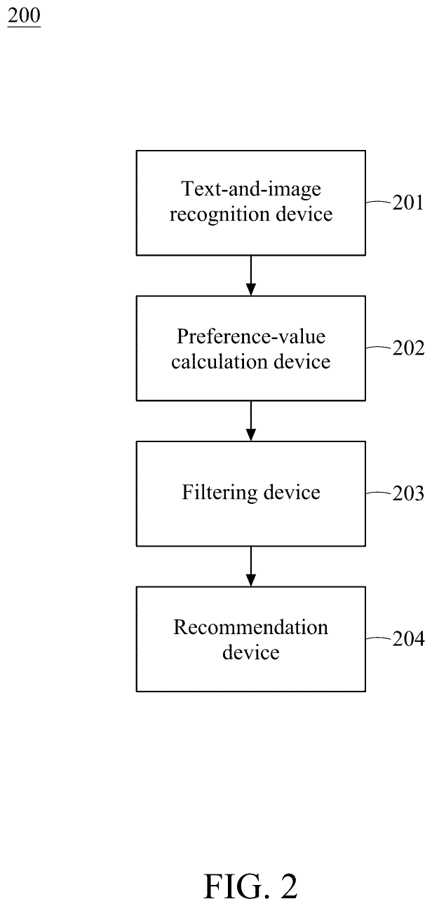

FIG. 2 shows a configuration block diagram of a matching system 200 for the illustrations and text descriptions in the specification according to an embodiment of the present invention.

As shown in FIG. 2, the matching system 200 of the present invention includes an image-and-text recognition device 201, a preference-value calculation device 202, a filtering device 203, and a recommendation device 204.

The matching system 200 of the present invention is, for example, a computer system, or an electronic device having a processor or a controller, which loads and executes programs through the processor or controller to achieve the required functions. The image-and-text recognition device 201, preference-value calculation device 202, filtering device 203, and recommendation device 204 are, for example, implemented by a processor or controller executing corresponding programs. In addition, the text-device 201, preference-value calculation device 202, filtering device 203, and recommendation device 204 can also be implemented by hardware such as Application Specific Integrated Circuit (ASIC) or Field Programmable Gate Array (FPGA).

In addition, the matching system 200 may further include an input device and a setting device (both not shown in FIG. 2). The input device is, for example, an interface such as a keyboard or mouse of a computer system for interacting with users. Using the matching system 200 of the present invention, the users (quality control personnels) can scan or upload specifications to the matching system 200 or database.

After the matching system 200 has received the uploaded specification or obtains the specification from the database, the specification is processed by the image-and-text recognition device 201. The image-and-text recognition device 201 finds the image blocks and text blocks on the specification through image recognition and text recognition; wherein the image blocks have corresponding covering ranges. The so-called “image block” refers to the range (or region) that includes one of the “illustrations” 11a˜11e as shown in FIG. 1 in the specification. The so-called “text block” refers to the range (or region) that includes one of the “text descriptions” 12a˜12e as shown in FIG. 1 in the specification. In more detail, the image block is a framed region indicating where the “illustration” is located after completing image recognition. In the following description, the illustration and the image block can be used interchangeably when used to indicate the framed region.

The image-and-text recognition device 201 performs image and text recognitions on the specification. The image-and-text recognition device 201 can, for example, recognize and frame the image blocks through an image segmentation model, for example. Moreover, the image-and-text recognition device 201, for example, uses Optical Character Recognition (OCR) to convert the graphics other than the illustrations shown in the specification into text formats, including numbers, symbols and general descriptive text, and to mark them as the text blocks. The image segmentation model is, for example, a machine learning model or a deep learning model that has been trained using commonly used illustrations in specifications, but is not limited thereto.

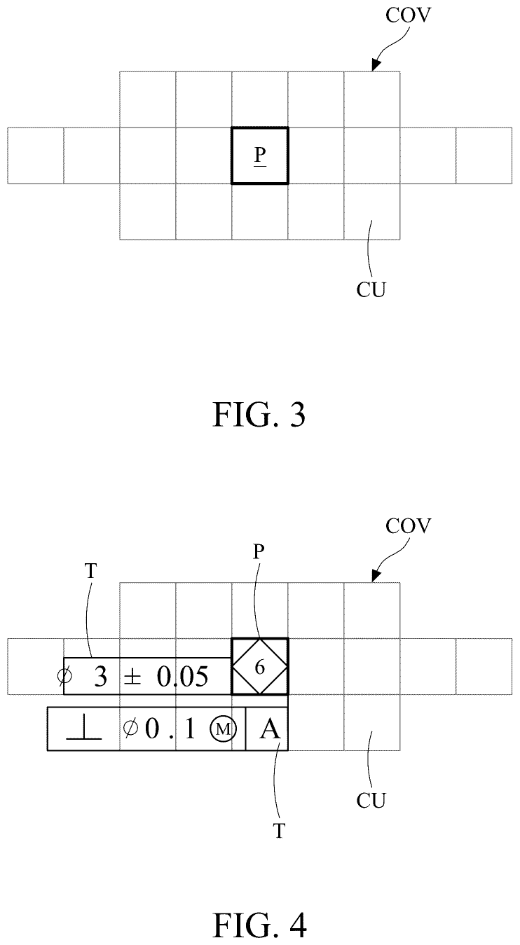

FIG. 3 shows a schematic diagram of the image block P and the corresponding covering range COV. FIG. 4 shows a schematic diagram of the image block P, the corresponding covering range COV, and the text block T.

In FIG. 3, the range marked P is the image block recognized by the image-and-text recognition device 201, and hereinafter it is referred to as the image block P. Take the size of the image block P as a basic unit. The covering range COV corresponding to the image block P is arranged with the image block P as the center, horizontally extending a first predetermined number of basic units (sub-ranges) CU to the left and right sides of the image block P respectively; and simultaneously horizontally extending a second predetermined number of units (sub-range) CU on the upper and lower sides of the image block P respectively, thereby defining the covering range COV as shown in FIG. 3. Here, the height of the image block P may be 1 to 1.5 times the size of the practically recognized graphic (or pattern). The coverage area and the number of sub-ranges CU of covering range COV can be set by the setting device.

Referring to FIG. 4, since the framed range corresponding to the text block T is usually a rectangle, if a circular covering range (not shown) is set with the image block Pas the center, then the upper and lower range will be too large, and it is easy to have the error that the framed range is not the corresponding text block T. Because different text blocks may be too close to each other, so the covering range COV cannot be too large. In addition, in the specifications, many text descriptions are arranged up and down (such as the text blocks T in FIG. 4); therefore, the covering range COV only sets the height of one image block P on the upper and lower sides of the image block P. The height of the image block P is equivalent to the range of multiple basic units (sub-ranges) in one row. In addition, since the text block T is usually a rectangle or composed of multiple rectangles, when the text block T is at the left and right sides of the image block P, the length of the covering range COV needs to be increased in order to have sufficient covering range. In FIG. 4 of this embodiment, the first predetermined number of basic units (sub-ranges), which are arranged to extend on the left and right sides of the image block P respectively, is preferably 3.5; and the second predetermined number of basic units (sub-ranges), which are arranged to extend on the upper and lower sides of the image block P respectively, is preferably 5, so as to cover the text blocks located diagonally.

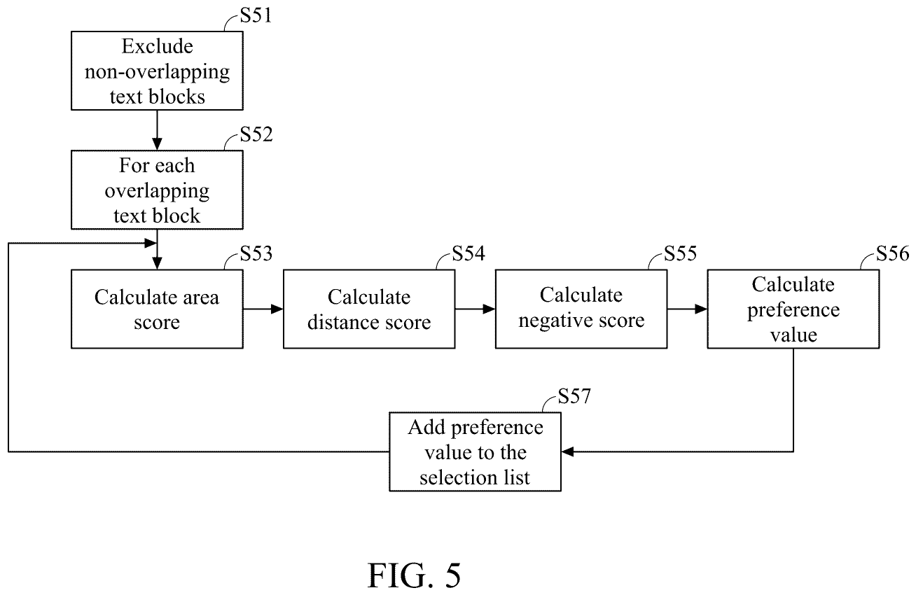

FIG. 5 shows a schematic diagram of the processing flow of the preference-value calculation device 202. For each image block in the specification, the preference-value calculation device 202 calculates the preference value of each text block associated with (overlapping with) the covering range COV of the image block. The following describes the process of calculating the preference value of each text block that overlaps with the covering range of the image block P.

First, the preference-value calculation device 202 excludes the text blocks that do not overlap the covering range COV of the image block P from all text blocks (step S51). For each text block that overlaps with the covering range COV of the image block P (step S52), calculate the overlapping area (in step S53) where the text block and the covering range COV of the image block P overlap each other, to obtain the area score of the text block. Next, in step S54, for each text block overlapping with the covering range COV of the image block P (also referred to as the overlapping text block), the distance from the image block P is calculated to obtain the distance score of the text block that overlaps with the covering range COV of the image block P. In step S55, the negative score of the text block overlapping with the covering range COV of the image block P is determined based on the location of the overlapping text block, the description format, and the covering range of the image block P. In step S56, the preference value of the overlapping text block is calculated based on the area score, distance score, and negative score, and the preference value of the text block is added to the selection list of the image block P (step S57). Afterwards, if the preference-value calculation device 202 determines that there are still overlapping text blocks for the image block P that have not been assigned preference values, the preference-value calculation device 202 repeats steps S53 to S57.

The following describes the manner for the preference-value calculation device 202 to calculate the area score (or called the overlapping area score). First, calculate the overlapping area intersectionₚₜ expressed as follows.

$${intersection}_{pt} = \vert Max ( 0 , Min ( {x}_{t 4} , {ux}_{p 4} ) - Max ( {x}_{t 1} , {ux}_{p 1} ) ) \times Max ( 0 , Min ( {y}_{t 4} , {uy}_{p 4} ) - Max ( {y}_{t 1} , {uy}_{p 1} ) ) \vert$$

Here, the width (Width) of the overlapping area is equal to the minimum value of x coordinate at the lower right corner minus the maximum value of x coordinate at the upper left corner, and the height (Height) of the overlapping area is equal to the minimum value of y coordinate at the lower right corner minus the maximum value of y coordinate at the upper left corner. The overlapping area is equal to the product of Width and Height.

The area scope Area_scopeₚₜ is expressed by the formula:

$${Area\_score}_{pt} = {W}_{2} \times \frac{\sum {intersection}_{pt}}{( {x}_{t 4} - {x}_{t 2} ) * ( {y}_{t 4} - {y}_{t 3} )}$$

where, (xₜ₁, yₜ₁), (xₜ₂, yₜ₂), (xₜ₃, yₜ₃), (xₜ₄, yₜ₄) represent the four coordinates of the text block; and (uxₚ₁, uyₚ₁), (uxₚ₂, uyₚ₂), (uxₚ₃, uyₚ₃), (uxₚ₄, uyₚ₄) represent the four coordinates of the sub-range of the covering range.

The covering range COV of the image block P is composed of multiple sub-ranges, and W2 is the weighting. Here, intersectionpt represents the overlapping area of one sub-range CU in the covering range COV and the text block. When the weighting W2 is 1, the Area_scoreₚₜ represents the area score, which is the sum of the overlapping areas of all sub-ranges in the covering range COV and the text block further divided by the area of the text block. In addition, please note that the +X direction of the coordinate axis is from left to right, and the +Y direction of the coordinate axis is from top to bottom.

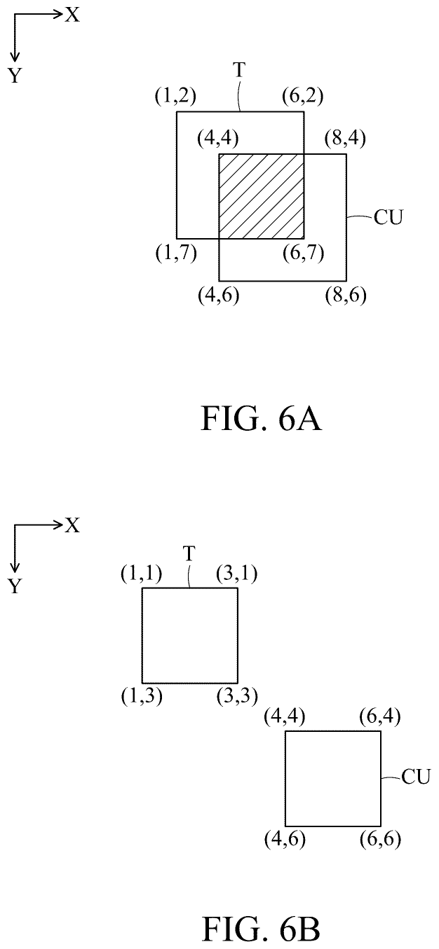

FIG. 6A shows an example of one sub-range (CU) of the covering range (COV) overlapping the text block (T). FIG. 6B shows an example of one sub-range (CU) of the covering range (COV) non-overlapping the text block (T).

Referring to FIG. 6A, the coordinates (x1, y1), (x2, y2), (x3, y3) and (x4, y4) of the text block T are (1, 2), (1, 7), (6, 2) and (6, 7) respectively, and the coordinates (x1, y1), (x2, y2), (x3, y3) and (x4, y4) of the sub-range CU are (4, 4), (4, 6), (8, 4) and (8, 6) respectively. Therefore, the calculations are as follows.

$$Width = Min ( 6 , 8 ) - Max ( 1 , 4 ) = 6 - 4 = 2 ,$$

$$Height = Min ( 7 , 6 ) - Max ( 2 , 4 ) = 6 - 4 = 2 , and$$

$$Area\_score = ( 2 \times 2 ) / ( ( 7 - 2 ) \times ( 6 - 1 ) ) = 4 / 25.$$

Referring to FIG. 6B, the coordinates (x1, y1), (x2, y2), (x3, y3) and (x4, y4) of the text block T are (1, 1), (1, 3), (3, 1) and (3, 3) respectively, and the coordinates (x1, y1), (x2, y2), (x3,y3) and (x4, y4) of the sub-range CU are (4, 4), (4, 6), (6, 4) and (6, 6) respectively. Therefore, the calculations are as follows.

$$Width = Max ( 0 , Min ( 3 , 6 ) - Max ( 1 , 4 ) ) = Max ( 0 , ( 3 - 4 ) ) = 0 ,$$

$$Height = Min ( 0 , Min ( 3 , 6 ) - Max ( 1 , 4 ) ) = Min ( 0 , ( 3 - 4 ) ) = 0 , and$$

$$Area\_score = ( 0 \times 0 ) / ( ( 3 - 1 ) \times ( 3 - 1 ) ) = 0 .$$

After calculating the area score, for example, the following area scores corresponding to the six text blocks which correspond to one image block are obtained.

| Text block | Area score |
|---|---|
| 1 | Area_score₁₁ = 0.3 × 1 × 100 = 30.00 |
| | Overlapping 100% |
| 2 | Area_score₁₂ = 0.3 × 0.8 × 100 = 24.00 |
| | Overlapping 80% |
| 3 | Area_score₁₃ = 0.3 × 1 × 100 = 30.00 |
| | Overlapping 100% |
| 4 | Area_score₁₄ = 0.3 × 0 × 100 = 30.00 |
| | Overlapping 100% |
| 5 | Area_score₁₅ = 0.3 × 0.7 × 100 = 21.00 |
| | Overlapping 70% |
| 6 | Area_score₁₆ = 0.3 × 0 × 100 = 0.00 |
| | Overlapping 0% |

The method of calculating the distance score by the preference-value calculation device 202 is explained below, according to the formula as shown below.

$${D}_{pt} = min ( \vert \frac{( {y}_{t 2} + {y}_{t 4} )}{2} - \frac{( {cy}_{p 1} + {cy}_{p 3} )}{2} \vert , \vert \frac{( {y}_{t 1} + {y}_{t 3} )}{2} - \frac{( {cy}_{p 2} + {cy}_{p 4} )}{2} \vert )$$

In this formula, N represents the sequence of the illustrations (the image blocks), such as 1, 2, 3 . . . , t represents the sequence of the text blocks, such as 1, 2, 3 . . . , and Dpt represents the minimum distance from the left and right boundaries of the image block P to the boundary of the text block T.

It should be noted that (xₜ₁, yₜ₁), (xₜ₂, yₜ₂), (xₜ₃, yₜ₃), (xₜ₄, yₜ₄) represent the four coordinates of the text block T; and (cxₚ₁, cyₚ₁), (cxₚ₂, cyₚ₂), (cxₚ₃, cyₚ₃), (cxₚ₄, cyₚ₄) represent the four coordinates of the image block P.

After obtaining the distance from the image block P to the text block T, perform the conversion based on the following formula.

$$DT = {\sum }_{t = 1}^{k} {D}_{t}$$

$${DL}_{pt} = \vert {Log}_{2} ( \frac{{D}_{pt}}{{DT}_{p}} ) \vert$$

DT is the sum of the distances (Dt) between a certain image block and the text blocks.

DLₚₜ represents the distance between the image block P and the text block T. The farther the distance is, the smaller the DLₚₜ will be, and after conversion, a positive value of DLₚₜ is taken for calculating the ratio.

Further, t represents the sequence of the text blocks, such as the first, second and third text blocks, and p represents the serial number of image blocks.

Then calculate the distance sum and average of all k text blocks in the covering range of the image block, as follows.

$$AD = \frac{{\sum }_{t = 1}^{k} {D}_{t}}{k}$$

AD represents the average distance between the image block and the text blocks, and t represents the sequence of the text blocks, such as the first, second and third text blocks.

Then calculate the score of the distance error to further obtain the distance score Distance_scoreₚₜ in the following manner.

$${DB}_{pt} = \sqrt{{( \frac{AD - {D}_{pt}}{AD} )}^{2}}$$

$${Distance\_score}_{pt} = {W}_{1} \times {DL}_{pt} + ( 1 - {W}_{1} ) * {DB}_{pt}$$

DBₚₜ represents the average distance error between the image block P and the text blocks T, and t represents the sequence of the text blocks, such as the first, second and third text blocks, and p represents the serial number of image blocks.

W1 represent the weighting of distance, and depends on different image blocks.

Assume that there are 5 text blocks T within the covering range of the image block P, and the total distance of the 5 text blocks is 25, the average distance is 6, and the weighting W1 is set to 0.7, then the distance scores have been calculated as follows. Furthermore, in this embodiment, generally the farther the distance, the lower the distance score.

| Text block | Distance score |
|---|---|
| 1 | ${Distance\_score}_{11} = ( 0 \text{.7} \times \vert {Log}_{2} ( \frac{4}{24} ) \vert + ( 1 - 0.7 ) \times ( \frac{2}{6} ) ) \times 100 = 64.47$ |
| | Distance 4 |
| 2 | ${Distance\_score}_{12} = ( 0 \text{.7} \times \vert {Log}_{2} ( \frac{4}{24} ) \vert + ( 1 - 0.7 ) \times ( \frac{2}{6} ) ) \times 100 = 64.47$ |
| | Distance 4 |
| 3 | ${Distance\_score}_{13} = ( 0 \text{.7} \times \vert {Log}_{2} ( \frac{8}{24} ) \vert + ( 1 - 0.7 ) \times ( \frac{2}{6} ) ) \times 100 = 44$ |
| | Distance 8 |
| 4 | ${Distance\_score}_{14} = ( 0 \text{.7} \times \vert {Log}_{2} ( \frac{2}{24} ) \vert + ( 1 - 0.7 ) \times ( \frac{4}{6} ) ) \times 100 = 95.54$ |
| | Distance 8 |
| 5 | ${Distance\_score}_{15} = ( 0 \text{.7} \times \vert {Log}_{2} ( \frac{6}{24} ) \vert + ( 1 - 0.7 ) \times ( \frac{0}{6} ) ) \times 100 = 42.14$ |
| | Distance 1 |

The method for determining the negative score Negative_scoreₚₜ by the preference-value calculation device 202 is explained below, according to the following formula.

$${Negative\_score}_{pt} = {W}_{3} \times \sum {Bad\_Score}_{pt}$$

ΣBAD_Scoreₚₜ represents the sum of total deduction.

W3 represents the weighting of negative scores, and different image blocks have different weighting values.

The preference-value calculation device 202 will further consider the problems associated with the text block as items for deductions. Such problems may be, for example but not limited to, the following cases. (1) The text block is surrounded by other texts, indicating that this text block may be an illustration in a text description or table content. (2) The text content within the text block fails to comply with the general size regulations. For example, there are two decimal points in the description of the number, or two dotted lines (‘--’) and other irregular contents, which may be caused by incorrect OCR recognition. (3) The frame range for marking the illustration is too large, as a result other illustrations are framed incorrectly. Such problems are attributed to image recognition, and can be judged based on the length and width of the image block. When there are the aforementioned (1) to (3) or other deduction items, for example, Bad_score=100 will be given. If there is no such situation, Bad_score=0 is given, but it is not limited to this. The negative scores can be an optimization option and can be omitted when calculating preference values.

For example, the text blocks 1 to 4 have the aforementioned situations (1) to (3), but the text block 5 does not, so the negative score is as follows. That is to say, if there are deduction situations such as the situations (1) to (3) mentioned above, the matching system 200 will tend not to use such text blocks and try to exclude them as much as possible.

| Text block | Negative score |
|---|---|
| 1 | Negative_score₁₁ = 0.5 × 0 = 0.00 |
| 2 | Negative_score₁₂ = 0.5 × 0 = 0.00 |
| 3 | Negative_score₁₃ = 0.5 × 0 = 0.00 |
| 4 | Negative_score₁₄ = 0.5 × 0 = 0.00 |
| 5 | Negative_score₁₅ = 0.5 × 100 = 50.00 |

The preference-value calculation device 202 calculates the preference value based on the area score Area_scorept, the distance score Distance_scorept, and the negative score Negative_scorept, as follows.

$${Text\_score}_{pt} = ( {Distance\_score}_{pt} + {Area\_score}_{pt} ) - {Bad}_{{score}_{pt}}$$

Where, t represents the sequence of text blocks, such as 1, 2, 3 . . . , and p represents the number of illustrations.

Text_scoreₚₜ represents the score of the text block T with respect to the image block P.

W4 represents weighting, and will be given different values based on the proportion of the text description in the text block.

The text block with a higher preference score is the text block that is most likely to be matched with the image block.

For example, provided that there are 5 text blocks within the covering range COV of the image block P, the preference value is calculated as follows.

| Text block | Preference value and description |
|---|---|
| 1 | Text_score₁₁ = (64.47 + 30) − 0 = 94.47 |
| | Preference value obtained when distance is 4, overlapping 100% |
| 2 | Text_score₁₂ = (64.47 + 24) − 0 = 88.47 |
| | Same distance 4 but lowrer overlapping, thus preference value still lower |
| 3 | Text_score₁₃ = (44 + 30) − 0 = 74.00 |
| | The farther the distance, the smaller the Log value. Even if the overlapping |
| | is 100%, the preference value is still lower than that of the closer one. |
| 4 | Text_score₁₄ = (95.54 + 30) − 0 = 125.54 |
| | The closest distance, thus highest preference value |
| 5 | Text_score₁₅ = (42.14 + 21) − 50 = 13.14 |
| | Distance is farther and overlapping is lower |

After calculating the preference value of each text block, it can be further determined whether each preference value meets the minimum standard, and those who meet the standard are added to the selection list of the image block P. The minimum standard is, for example, a value determined by considering distance, coverage, and the aforementioned logarithmic value (Log value).

When there are multiple text blocks in the selection list of one illustration (image block), the matching system 200 needs to use a suitable strategy to determine the correct matching relationship, and at the same time filter out the text blocks that are irrelevant to the image block. Such processing flow is mainly performed by the filtering device 203 of this embodiment.

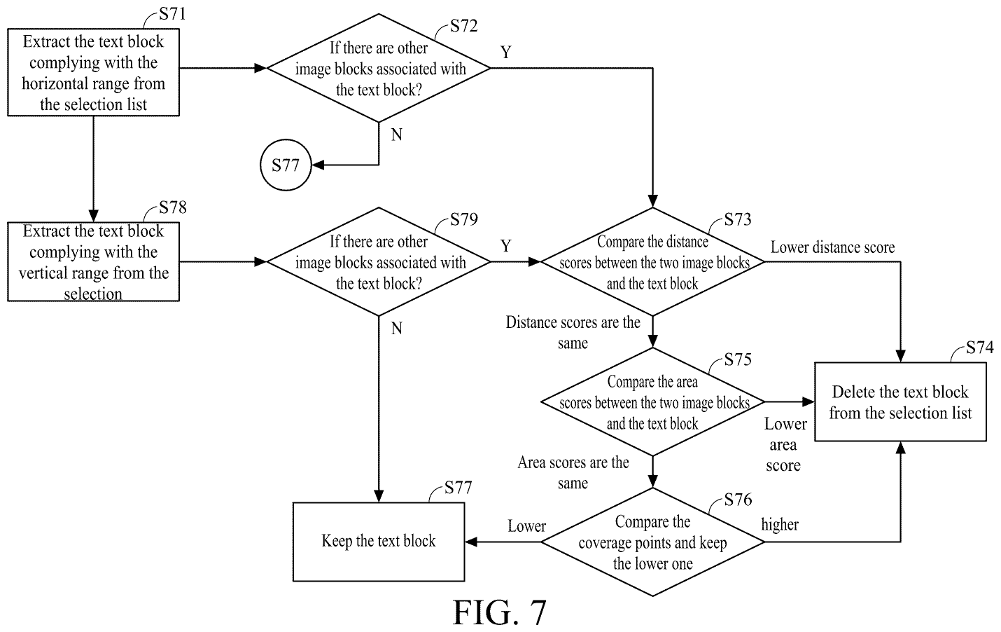

FIG. 7 shows the operation flow of the filtering device 203 of this embodiment. The operation of the filtering device 203 is described below.

The matching system 200 will perform horizontal and vertical calculations on each text block, and further consider the position of the text block relative to the image block, thereby adopting different strategies for more accurate matching. The matching system 200 can use the filtering device 203 to perform horizontal and vertical judgments on each text block, but is not limited to this and can also be performed by other devices.

To determine whether a text block is in a horizontal range or a vertical range will be described as follows. The horizontal or vertical judgment mainly uses the center points of the left and right edges of the text block and the image block to calculate their relative angle. The formula is as follows:

$${Angle}_{nt} = Max ( A tan ( \frac{\vert \frac{( {y}_{t 3} + {y}_{t 4} )}{2} - \frac{( {cy}_{p 1} + {cy}_{p 2} )}{2} \vert}{\vert \frac{( {x}_{t 3} + {x}_{t 4} )}{2} - \frac{( {cx}_{p 1} + {cx}_{p 2} )}{2} \vert} ) , \\ A tan ( \frac{\vert \frac{( {y}_{t 1} + {y}_{t 2} )}{2} - \frac{( {cy}_{p 3} + {cy}_{p 4} )}{2} \vert}{\vert \frac{( {x}_{t 1} + {x}_{t 2} )}{2} - \frac{( {cx}_{p 3} + {cx}_{p 4} )}{2} \vert} ) ) \times 100$$

wherein (xₜ₁, yₜ₁), (xₜ₂, yₜ₂), (xₜ₃, yₜ₃) and (xₜ₄, yₜ₄) represent four coordinates of the text block T, and (cxₚ₁, cyₚ₁), (cxₚ₂, cyₚ₂), (cxₚ₃, cyₚ₃) and (cxₚ₄, cyₚ₄) represent four coordinates of the image block T. In addition, if the angle Angleₚₜ is less than 45 (degrees), the text block T is considered in the horizontal range, otherwise it is considered in the vertical range.

For example, the text block has four coordinates (x1,y1)=(1,1), (x2,y2)=(1,3), (x3,y3)=(3,1), and (x4,y4)=(3,3). Then, the center point on the right side of the text block is (3, 2) and the center point on the left side of the text block is (1, 2). The image block has four coordinates (xp1,yp1)=(6,2), (xp2,yp2)=(6,4), (xp3,yp3)=(9,2) and (xp4,yp4)=(9,4). Then, the center point on the right side of the image block is (6, 3) and the center point on the left side of the image block is (9, 3).

For the right side of the text block relative to the left side of the image block P, the calculation result is:

$$Angle 1 = a tan ( ( 3 - 2 ) / ( 6 - 3 ) ) \times 100 = a tan ( 1 / 3 ) \times 100 = 32.$$

For the left side of the text block relative to the right side of the image block P, the calculation result is:

$$Angle 2 = a tan ( ( 3 - 2 ) / ( 9 - 1 ) ) \times 100 = a tan ( 1 / 3 ) \times 100 = 12.4$$

The Anglept is 32 by taking the larger one of Angle1 and Angle 2, so the text block is considered to be in a horizontal position relative to the image P.

Here, it is assumed that the matching system 200 adopts a matching strategy of horizontal priority. First, the filtering device 203 extracts the text blocks that comply with the horizontal range from the selection list of the image block P (step S71). Then, the filtering device 203 determines whether the text blocks in the horizontal range are associated with other image blocks (step S72). If there are other image blocks (such as the image block Q) associated with the text block (step S72: Yes), the filtering device 203 compares the distance score between the image block P and the text block, and the distance between the image block Q and the text block (step S73). If no other image block is associated with the text block (step S72: No), the text block is retained in the selection list of the image block P (step S77).

In step S73, if determining the distance score between the text block and the image block Q is lower, the text block is deleted from the selection list of the image Q (step S74). If determining the distance scores of the text block and the image blocks P and Q are the same, the area scores of the text block relative to the image blocks P and Q respectively are further compared in step S75.

If the area score of the text block relative to the image Q is lower, the text block is deleted from the selection list of the image block Q (step S74). In step S75, if the area scores of the text block associated with the image blocks P and Q respectively are the same, then the coverage points of the text block associated with the images blocks P and Q respectively are further compared in step S76. According to the comparison result, the one with a lower coverage point is retained in the selection list of the image block P (step S77), and the other with a higher coverage score is deleted from the selection list of the image block P (step S74).

In addition, the filtering device 203 also finds the text blocks that meet the vertical range from the selection list of the image block P (step S78). Then, the filtering device 203 determines whether the text block in the vertical range is associated with other image blocks (step S79). If there are other image blocks (such as the image block R) associated with the text block (step S79: Yes), the filtering device 203 further compares the distance scores of the text block between the image block P and the image block R (step S73). If no other image block is associated with the text block (step S79: No), the text block is retained in the selection list of the image P (step S77). In step S73, if the distance score between the text block and the image block R is lower, the text block is deleted from the selection list of the image block R (step S74). If the distance scores between the text block and the image blocks P and R are the same, the area scores between the text block and the image blocks P and R are further compared in step S75. If the area scores of the text block and the image block R are lower, the text is deleted from the selection list of the image block R (step S74). If the area scores of the text block respectively related to the image blocks P and R are the same, then the coverage point of the text block associated with the image block P and the coverage point of the text block associated with the image block R are compared in step S76. According to the comparison result, the one with a lower coverage point is retained in the selection list of the image block P (step S77), and the other with a higher coverage point is deleted from the selection list of the image block P (step S74).

The matching system 200 of this embodiment uses the filtering device 203 to execute the aforementioned process, and can intelligently select and filter text blocks according to the needs of different image blocks.

The coverage point is calculated according to the following formula:

$${Area\_TotalScore}_{p} = \frac{{\sum }_{t = 1}^{k} {Area\_score}_{pt}}{k}$$

wherein Area_scopeₚₜ represents the area score of the text block T relative to the image block P; Area_TotalScopeₚₜ represents the total overlapping area score of the image block P; and t represents the serial number of text block, such as 1, 2, 3 . . . , and p is the serial number of illustrations (image blocks).

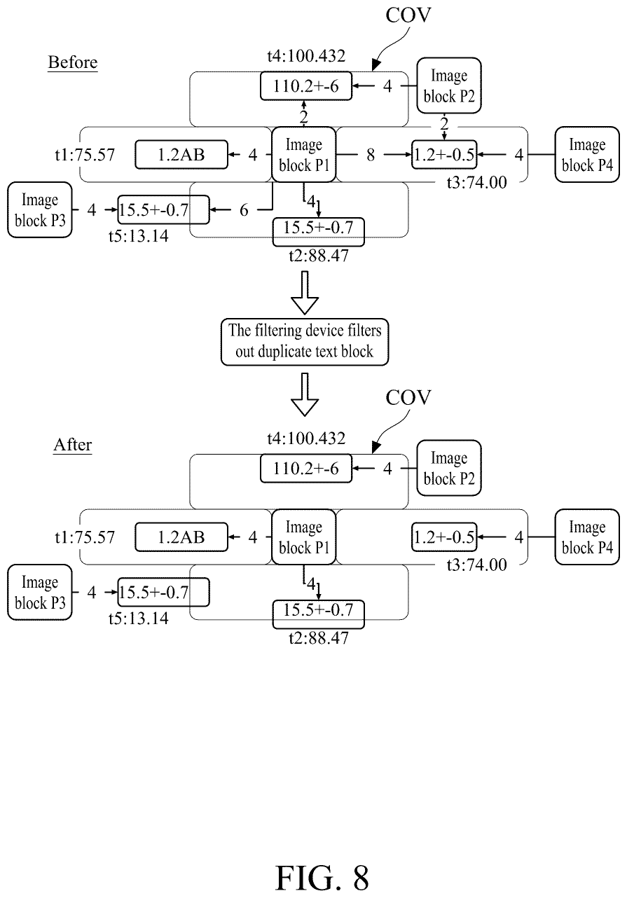

Referring to FIG. 8, the following describes the correspondence between the image blocks and the text blocks before and after processing by the filtering device 203.

Referring to FIG. 8, the section above the filtering device 203 is called (marked as) the “Before” section, and the section below the filtering device 203 is called (marked as) the “After” section. The “Before” section schematically shows the preference scores, distances, relative positions of the text blocks t1 to t5 corresponding to the illustrations (the image blocks) P1 to P4 before processing of the filtering device 203. Moreover, the “After” section below the filtering device 203 schematically shows the preference scores, distances, relative positions of the text blocks t1 to t5 corresponding to the illustrations (the image blocks) P1 to P4 after processing of the filtering device 203.

In the “Before” section, there are the text blocks t1˜t4 in the selection list of the image block P1, and their preference values associated with the image P1 are 75.57, 88.47, 74.00, and 100.432 respectively, and their distances from the image block P1 are 4 (horizontal), 4 (vertical), 8 (horizontal) and 2 (horizontal) respectively.

For the image block P1, first, the filtering device 203 searches for the text blocks complying with the horizontal range, and then obtains the text blocks t1 and t3 in the horizontal range (step S71). In step S72, the filtering device 203 determines that the text block t1 is not related to the other images blocks (P2˜P4), so the text block t1 is reserved in the selection list of the image block P1 (step S77). In step S72, the filtering device 203 determines that the text block t3 is also related to other image block P4 (step S72: Yes), so the filtering device 203 further compares the distance between the text block t1 and the image block P1 with the distance between the text block t3 and the image block P4 (step S73). The practical distance of the text block t1 is smaller than that of the text block t3 (that is, the distance score of the text block t1 is greater than the text block t3), and therefore the text block t3 with a lower distance score will be deleted from the selection list of image block P1 (step S74).

For the image block P1, the filtering device 203 also searches for the text blocks complying with the vertical range, and then obtains the text blocks t2, t4 and t5 in the vertical range (step S78). In step S79, the filtering device 203 determines that the text block t2 is not related to the other images blocks (P2˜P4), so the text block t2 is reserved in the selection list of the image block P1 (step S77). In step S79, although it is determined that the text block t4 is also related to other image blocks P2, because the matching system 200 adopts the horizontal priority strategy and the image block P2 is only related to the text block t4 in the horizontal range, the filtering device 203 will reserved the text block t4 for the image block P2. Therefore, the text block t4 is deleted from the selection list of the image block P1. Similarly, in step S79, although it is determined that the text block t5 is also related to the other image block P3, because the matching system 200 adopts the horizontal priority strategy, and the text block t5 is only related to the image block P3 in the horizontal range, the filtering device 203 will reserve the text block t5 for the image block P3. Therefore, the text block t5 is deleted from the selection list of the image block P1.

In FIG. 8, the “After” section below the operation of the filtering device 203 shows a schematic diagram of the relationship between the image blocks P1 to P4 and the text blocks after processing of the filtering device 203. The selection list of the image block P1 includes the text blocks t1 and t2, and the selection lists of P2 to P4 include the text blocks t4, t5 and block t3, respectively.

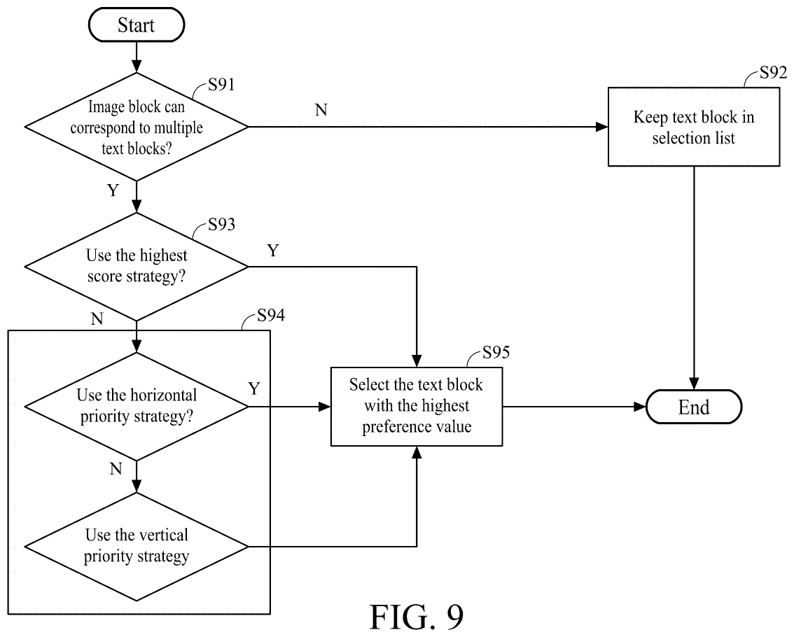

FIG. 9 shows an operation flow of the recommendation device 204 in the matching system 200 of this embodiment. The operation of the recommendation device 204 will be described below with reference to FIG. 9.

After processing of the filtering device 203, the recommendation device 204 determines whether the image block P can correspond to multiple text blocks (step S91). When the selection list of the image block P has only one text block (step S91: No), the recommendation device 204 retains this text block (step S92). When the image block P can correspond to multiple text blocks (step S91: Yes), the recommendation device 204 can use the highest score strategy (step S93) or the relative position strategy (including horizontal priority strategy or vertical priority strategy) (step S94), for selecting the text block in the selection list of the image block P.

When based on the highest score strategy (step S93), the recommendation device 204 selects the text block with the highest preference value in the selection list to be matched with the image block P (step S95). When based on the relative position strategy (step S94), if the horizontal priority strategy is adopted, the recommendation device 204 first deletes the text block in the vertical range, and then selects the text block with the highest preference value and matches it with the image block P (step S95); if the vertical priority strategy is adopted, the recommendation device 204 can first delete the text block in the horizontal range, and then select the text block with the highest preference value and match it with the image block P (step S95). After matching according to the highest score strategy or the relative position strategy, the recommendation device 204 further deletes unmatched text blocks in the selection list of the image block P.

Referring to the “After” section in FIG. 8, the one with the highest score may not necessarily be retained, for example, t4 is filtered out from the selection list of the image block P1. Because the image block P2 only corresponds to the text block t4, the text block t4 will be assigned preferentially to the image block P2, and is deleted from the selection list of the image block P1. When the image block P1 corresponds to the text blocks t1 and t2, if the image block P1 can only correspond to one text block, then t2 will be selected (because t2:88.47>t1:75.57) if the selection is based on the highest score strategy. If the selection is based on the horizontal priority strategy, t1 will be selected for the image block P1, and t3 will be assigned to the image block P4 instead of the image block P2. If the vertical priority strategy is used for selection, t2 will be assigned to the image block P1. If the image block P1 can correspond to multiple text blocks, there is no need to select from the text blocks t1 and t2.

According to the matching system of the present invention, it can be applied to match the illustrations and the text descriptions in the specifications. By automating the matching process, the matching system of the present invention can improve the efficiency of marking, reduce time costs, and reduce artificial marking errors.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A matching system for images and text descriptions in a specification, comprising:
an image-and-text recognition device, configured to receive a specification, and to recognize image blocks and text blocks on the specification; wherein the image blocks have corresponding covering ranges; and
a preference-value calculation device, configured to assign preference values to the text blocks for matching with the image blocks based on position relationships between the text blocks and the image blocks, and content characteristics of the text blocks.

2. The matching system as claimed in claim 1, wherein the preference-value calculation device is further configured to:
calculate overlapping areas of the text blocks and the covering range of a first image block among the image blocks, and obtain area scores of the text blocks which overlap the first image block;
for the text blocks which overlap the first image block, calculate distances from the first image blocks to obtain distance scores of the text blocks;
based on positions and descriptive forms of the text blocks which overlap the first image block, and a frame range of the first image block, determine negative scores of the text blocks which overlap the first image block; and
based on the area scores, distance scores and negative scores, calculate the preference values of the text blocks which overlap the first image block.

3. The matching system as claimed in claim 2, wherein the preference-value calculation device is further configured to add the text blocks having preference values that satisfy a selection condition to a selection list of the first image block.

4. The matching system as claimed in claim 3, further comprising a filtering device;
wherein when a first text block in the selection list of the first image block is associated with a second image block of the image blocks, the filtering device determines whether to keep or delete the first text block in the selection list of the first image block based on the distance scores, the area scores, and coverage points.

5. The matching system as claimed in claim 4, wherein the coverage point is expressed by the formula:
$${Area\_TotalScore}_{p} = \frac{{\sum }_{t = 1}^{k} {Area\_score}_{pt}}{k}$$
wherein p represents the number of image blocks, k represents a total number of all the text blocks which overlap the image blocks p, and Area_scorept corresponds to a total overlapping area of k text blocks which overlap the image blocks p.

6. The matching system as claimed in claim 4, wherein the filtering device is configured to compare the distance scores of the first text block corresponding to the first image block and the second image block respectively;
when the distance score of the first text block is lower, the first text block is deleted from the selection list of the first image block;
when the distance scores of the first text block corresponding to the first image block and the second image block respectively are the same, the filtering device further compares the area scores of the first text block corresponding to the first image block and the second image block respectively, and when the area score of the first text block corresponding to the first image block is lower, the first text block is deleted from the selection list of the first image block; and
when the area scores of the first text block corresponding to the first image block and the second image block respectively are the same, the filtering device further compares the coverage points of the first text block corresponding to the first image block and the second image block respectively, in addition, when the coverage point of the first text block is lower, the first text block is kept in the selection list of the first image block, and when the coverage point of the first text block is higher, the first text block is deleted from the selection list of the first image block.

7. The matching system as claimed in claim 5, wherein the filtering device is configured to compare the distance scores of the first text block corresponding to the first image block and the second image block respectively;
when the distance score of the first text block is lower, the first text block is deleted from the selection list of the first image block;
when the distance scores of the first text block corresponding to the first image block and the second image block respectively are the same, the filtering device further compares the area scores of the first text block corresponding to the first image block and the second image block respectively, and when the area score of the first text block corresponding to the first image block is lower, the first text block is deleted from the selection list of the first image block; and
when the area scores of the first text block corresponding to the first image block and the second image block respectively are the same, the filtering device further compares the coverage points of the first text block corresponding to the first image block and the second image block respectively, in addition, when the coverage point of the first text block is lower, the first text block is kept in the selection list of the first image block, and when the coverage point of the first text block is higher, the first text block is deleted from the selection list of the first image block.

8. The matching system as claimed in claim 6, further comprising a recommendation device;
wherein when the selection list of the first image block has only one text block, the recommendation device keeps the text block;
when the selection list of the first image block has multiple text blocks, the recommendation device selects one text block in the selection list of the first image block based on a highest score strategy or a relative position strategy;
wherein when based on the highest score strategy, the recommendation device selects to match the text block with the highest preference value in the selection list to the first image block; and
when based on the relative position strategy, the recommendation device selects the text block which is arranged horizontally or vertically relative to the first image block and has the highest preference value among the text blocks in the selection list.

9. The matching system as claimed in claim 8, wherein after the recommendation device has selected the matched text block according to the highest score strategy or the relative position strategy, the recommendation device deletes the unmatched text blocks in the selection list at the same time.

10. The matching system as claimed in claim 1, wherein the size of the image block is taken as basic unit; and
the covering range corresponding to the image block is arranged with the image block as the center, horizontally extending a first predetermined number of basic units to the left and right respectively, and on the upper and lower sides of the image block horizontally extending a second predetermined number of basic units.

11. The matching system as claimed in claim 10, wherein the first predetermined number is 3.5, and the second predetermined number is 5.
